(19) United States
(12) Patent Application Publication
(10) Pub. No.: US 2008/0207210 A1
(43) Pub. Date: Aug. 28, 2008

(54) Apparatus and Method for Frequency Planning for a Cellular Communication System

(75) Inventor: Simon Brusch, Wiltshire (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/067,999

(22) PCT Filed: Nov. 28, 2006
(86) PCT No.: PCT/US06/45474

§ 371 Date: Mar. 25, 2008

(30) Foreign Application Priority Data
Dec. 14, 2005 (GB) 0525433.9

(51) Int. Cl. H04Q 7/22

(52) U.S. Cl. 455/447

(57) ABSTRACT

The invention relates to frequency planning in a cellular communication system, such as a GSM cellular communication system. An apparatus for frequency planning comprises an interference matrix processor (201) which generates an interference matrix comprising interference relationships between different cells. For example, carrier to interference or interference penalty values for cell pairs can be determined. An interference matrix limiter (203) limits the number of interference relationships to a first number, N, of highest interference relationships for each cell. The first number N can be determined in response to the re-use pattern and number of frequencies available for the frequency plan. A frequency plan processor (205) then proceeds to perform a frequency planning using the interference matrix.

### FIELD OF THE INVENTION

The invention relates to an apparatus and method for frequency planning for a cellular communication system and in particular, but not exclusively, to frequency planning for a Global System for Mobile communication (GSM) cellular communication system.

### BACKGROUND OF THE INVENTION

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

3rd generation systems have recently been rolled out in many areas to further enhance the communication services provided to mobile users. One such system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876. The core network of UMTS is built on the use of SGSNs and GGSNs thereby providing commonality with GPRS.

In order to optimise the capacity of a cellular communication system, it is important to minimise the impact of interference caused by or to other mobile stations. Thus, it is important to minimise the interference caused by the communication to or from a mobile station, and consequently it is important to use the lowest possible transmit power.

An important advantage of cellular communication systems is that, due to the radio signal attenuation with distance, the interference caused by communication within one cell is negligible in a cell sufficiently far removed, and therefore the resource can be reused in this cell. In GSM systems, carrier frequencies are therefore reused in other cells in accordance with a frequency plan. Frequency planning is one of the most important optimisation operations for a cellular communication system in order to maximise the communication capacity of the system. The frequency planning typically considers a vast number of parameters including propagation characteristics, traffic profiles and communication equipment capabilities.

Specifically, known frequency planning methods rely heavily on interference estimations between different cells. Automatic frequency planning methods have been developed wherein potential cross-interference and resulting carrier to interference ratios are determined for different possible frequency allocations. Typically, an interference level is determined as the interference caused to a communication between a mobile station and a base station in one cell by a potential communication between a mobile station and base station in a different cell. Conventionally, the interference is determined from propagation predictions based on calculated and measured propagation characteristics.

Due to the large number of possible frequency plans and the complex interference interrelations between different cells, frequency planning is typically achieved by use of Automatic Frequency Planning (AFP) tools which typically take in a list of interference relationships between cells and interferers to produce a frequency plan that minimises interference. The interference relationships quantify the interference in a cell from each potential interferer. The AFP will then use this information to produce a frequency plan that minimises the effect of the interference. Typically, a complex search and iterative optimisation technique is used to determine the best frequency plan.

Specifically, most AFP tools are based on the use of an interference matrix which for each cell pair has an entry that indicates the interference relationship between these cells.

The values in an interference matrix are often penalty values, where the higher the penalty the worse the effect of interference from that interferer. Some AFPs use positive values where the lower the value the worse the impact of the interference.

The length of time taken to produce a frequency plan depends on the number of interference relationships between cells that must be considered. Furthermore, the complexity and computational requirement increases substantially for increasing numbers (i.e. it is a non-linear increment that increases with a power of more than one). Typically all values above a certain threshold are included in the interference matrix with smaller values being disregarded or set to zero.

However, although substantial effort has been dedicated to the area of optimising the AFP search algorithm and fitness function to improve performance, conventional approaches do not address the issue of very large matrices. For example complex areas with high amounts of cell overlap produce interference matrices with many interference relationships per cell, typically several hundred. However, this can result in very large interference matrices with many interference relationships to be considered by the AFP tool leading to high complexity, high computational resource requirements and slow AFP operation. Furthermore, this may lead to a restriction in the number of cells being considered by each planning operation. For example, a given area may be divided into a number of sub-areas with each of these being individually optimised. However, this results in a sub-optimal frequency plan and thus in a degraded performance of the cellular communication system as a whole.

Hence, an improved system for frequency planning would be advantageous and in particular a system allowing for reduced complexity, reduced resource requirements, faster frequency planning and/or improved frequency planning would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a method of frequency planning for a cellular communication system, the method comprising: generating an interference matrix comprising interference relationships between different cells; for each cell of the interference matrix limiting a number of interference relationships to a first number of highest interference relationships; and performing a frequency planning using the interference matrix.

The invention may allow improved frequency planning for a cellular communication system. A substantial reduction in the number of interference relationships to consider can be achieved while maintaining sufficient data for an accurate and efficient frequency planning. A reduced complexity, computational resource and/or time required for the frequency planning can be achieved. Specifically, a maximum resource requirement for the frequency planning process can be assumed which is independent of the specific interference relationships that exist for the individual system to be optimised. The invention may allow a combined frequency planning of a larger area and/or the application of an improved and more complex frequency planning algorithm. An improved performance of the resulting communication system following the implementation of the revised frequency plan can be achieved.

The highest interference relationships are the interference relationships for the cells which correspond to the highest interference between the cells. In particular, the highest interference relationship can correspond to the interference relationships resulting in the highest penalty values.

According to an optional feature of the invention, the method further comprises determining the first number in response to a frequency re-use pattern for the cellular communication system.

This may allow improved performance and may in particular allow an efficient and flexible trade-off between the accuracy of the frequency planning and the complexity reduction for the frequency planning process. Furthermore, the trade-off can be adapted to the specific requirements and conditions for the specific system to be optimised.

According to an optional feature of the invention, the method further comprises determining the first number in response to a number of frequencies available for the frequency planning.

This may allow improved performance and may in particular allow an efficient and flexible trade-off between the accuracy of the frequency planning and the complexity reduction for the frequency planning process. Furthermore, the trade-off can be adapted to the specific requirements and conditions for the specific system to be optimised.

According to an optional feature of the invention, the number of frequencies includes a number of available frequencies not allocated to the reuse pattern.

This may allow improved performance and may in particular allow an efficient and flexible trade-off between the accuracy of the frequency planning and the complexity reduction for the frequency planning process. Furthermore, the trade-off can be adapted to the specific requirements and conditions for the specific system to be optimised. In particular, the feature may allow that the impact of joker or wildcard frequencies (i.e. frequencies which are available in addition to the reuse frequencies) is taking into consideration for the trade-off.

According to an optional feature of the invention, the first number is determined as the number of available frequencies multiplied by a constant.

This may allow a simple yet efficient determination of a suitable number of interference relationships to keep for each cell.

According to an optional feature of the invention, the constant is between one and three.

This may allow efficient performance of the frequency planning which achieves both low complexity and accurate frequency planning. In particular, a constant between one and three will result in a substantial complexity reduction with a typically negligible impact on the resultant frequency plan.

According to an optional feature of the invention, the limiting is by setting matrix values for cell combinations not corresponding to the first number of highest interference relationships to a value indicative of no interference existing between cells associated with the matrix values.

This may allow an efficient, low complexity and practical implementation. For example, for penalty values in the interference matrix, the penalty value may be set to zero (indicative of no penalty arising from allocating the same frequency to the cells associated with the value).

According to an optional feature of the invention, the limiting is such that if an interference relationship between a first and a second cell is one of the first number of highest interference relationships for interference from the first to the second cell, the interference relationship for interference from the second cell to the first cell is maintained in the interference matrix.

This may provide improved performance and may in particular reduce the impact of the complexity reduction. If an interference relationship between two cells is within the first number of highest interference relationships for interference in one direction, the interference relationship for interference in the other directions is also maintained in the interference matrix irregardless of whether this interference relationship is one of the first number of highest interference relationships. Thus, dual relationships (i.e. in both directions) may be maintained leading to improved accuracy.

According to an optional feature of the invention, the interference relationship comprises a plurality of interference relationships for a set of carrier frequencies.

This may provide improved performance and may in particular allow increased flexibility and detail of the frequency planning.

According to an optional feature of the invention, the set of carrier frequencies are divided into a first and second set of non-overlapping carrier frequencies and the first number comprises a second number corresponding to interference relationships of carrier frequencies in the first set and a second number corresponding to interference relationships of carrier frequencies in the second set.

This may provide improved performance and may in particular allow an improved and more efficient frequency plan to be determined. The first and second sets of carrier frequencies may for example correspond to carrier frequencies in different frequency bands or different cell layers.

According to an optional feature of the invention, the cellular communication system is a GSM cellular communication system.

The invention may allow for an improved frequency planning for a GSM cellular communication system.

According to another aspect of the invention, there is provided, an apparatus for frequency planning of a cellular communication system, the apparatus comprising: means for generating an interference matrix comprising interference relationships between different cells; means for, for each cell of the interference matrix, limiting a number of interference relationships to a first number of highest interference relationships; and means for performing a frequency planning using the interference matrix.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates the inter-relationship between different types of network elements in a GSM cellular communication system;

FIG. 2 illustrates a frequency planning apparatus in accordance with some embodiments of the invention; and

FIG. 3 illustrates a method of frequency planning in accordance with some embodiments of the invention.

### DETAILED DESCRIPTION OF SOME EMBODIMENTS OF THE INVENTION

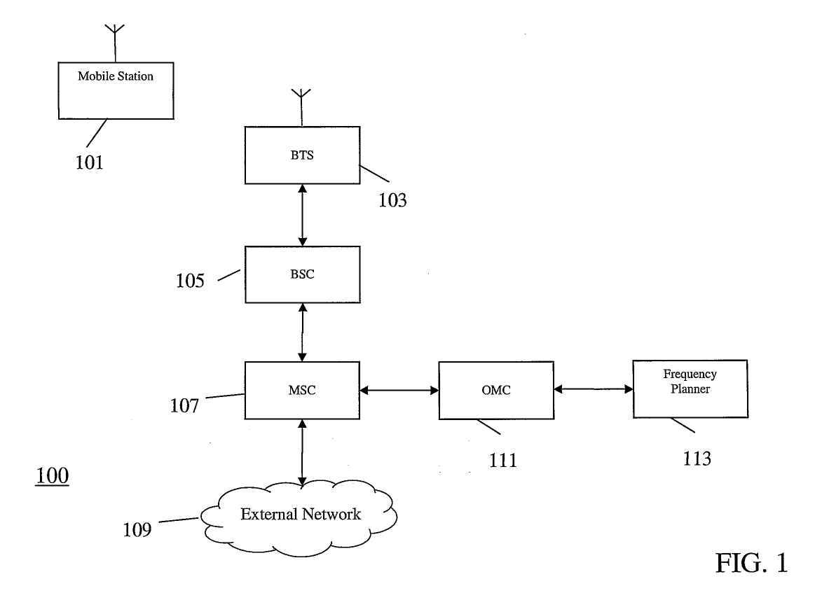

The following description focuses on an embodiment of the invention applicable to frequency planning for a GSM cellular communication system. However, it will be appreciated that the invention is not limited to this application but may be applied to many other applications and communication systems. Specifically, the invention will be described with reference to a communication systems such as that illustrated in FIG. 1.

FIG. 1 illustrates the inter-relationship between different types of network elements in a GSM cellular communication system.

A mobile station (MS) 101 is able to move within the coverage area of the cellular communication system receiving communication services from a plurality of base transceiver stations (BTS), each serving a cell covering a portion of the total coverage area of the cellular communication system. At any one time while the MS 101 is switched on, the MS 101 is in radio communication contact with its serving BTS 103 and may be exchanging control or signaling information with BTS 103 when the MS 101 is in an idle state, and may be exchanging speech or data traffic information along with control or signaling information with BTS 103 in an active state.

The BTS 103 is coupled to a base station controller (BSC) 105 that controls the operation of the BTS 103, and typically also controls the operation of a number of other BTSs of the cellular communication system (not shown for clarity). The BSC 105 in turn is coupled to a Mobile Switching Center (MSC) 107. The MSC 107 is coupled to an external network 109, such as the public switched telephone network PSTN and is also coupled to other MSCs of the cellular communication network (not shown for clarity). The MSC 107 routes speech or data traffic information from or to the MS 101 and to or from other MSCs to which it is connected and/or to the external network 109. Typically the MSC 107 will also be coupled to a number of other BSCs/BTSs.

The MSC 107 is also operably connected to an Operations and Maintenance Centre (OMC) 111. The function of the OMC 111 is to monitor and control the operation of the cellular communication network. In particular, the OMC 111 may store the cell frequencies and neighbor data for the cells of the network.

The network elements illustrated in FIG. 1 and as described above are conventional network elements of a GSM network. It will be clear to a skilled person that additional network elements would be present in an actual network. These additional elements are not essential to the present invention and have therefore been omitted for clarity.

However, the invention is not intended to be limited to a GSM network, as illustrated and a network incorporating additional or alternative network elements such as network elements for supporting packet data transfer, for example in accordance with the General Packet Radio System (GPRS) and/or network elements in accordance with third generation communication systems such as the Universal Mobile Communication System (UMTS) being standardized by the Third Generation Partnership Project (3GPP) of the European Telecommunication Standards Institute (ETSI) or CDMAOne, may utilize the principles of the invention.

A network planner 113 is also provided in the embodiment shown in FIG. 1, shown as operably coupled to the OMC 111. The network planner 113 includes functionality for data collection for data analysis and network planning.

It will be recognized by a skilled person that the network planner 113 may be provided as part of the OMC function, or in a separate device, for example a separate device operably coupled to a switching center (MSC 107) or may be distributed between different network elements. In particular, it is not necessary for the data collection functionality, the data analysis functionality and the network planning functionality to be located within the same device or network element. As such the network planner 113 may be provided by a separate device of the cellular communication system or by a new OMC in the cellular communication system or the network planner 113 function may be provided as a software upgrade to an existing OMC or any other network device of the cellular communication system.

The network planner 113 in accordance with some embodiments of the invention is preferably implemented as processor-implementable instructions stored on any storage media, for example but not limited to: floppy disk, hard disk, Read Only Memory (ROM), Programmable Read Only Memory (PROM), Erasable Programmable Read Only Memory (EPROM), Random Access Memory (RAM) and such like.

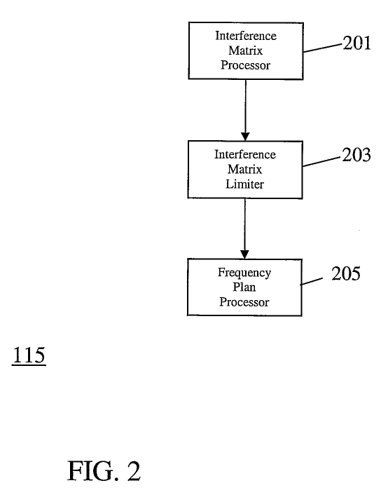

FIG. 2 illustrates a frequency planning apparatus in accordance with some embodiments of the invention. In particular, FIG. 2 illustrates the frequency planner 113 of FIG. 1 in more detail.

The frequency planner 113 comprises an interference matrix processor 201 which generates an interference matrix comprising interference relationships between different cells of the cellular communication system.

The interference matrix processor 201 is coupled to an interference matrix limiter 203 which is arranged to limit the number of interference relationships for each cell of the interference matrix to a given number, N. The interference matrix limiter 203 specifically limits the interference relationships to the N interference relationships which are indicative of the highest interference between the corresponding cells. For example, the N interference matrix entries in each column corresponding to the highest penalty values or the lowest carrier to interference ratio are selected.

The interference matrix limiter 203 is coupled to a frequency plan processor 205 which is arranged to perform a frequency planning based on the limited interference matrix. Many different algorithms for determining an optimized frequency plan based on an interference matrix are known. Most of these algorithms use advanced search and iterative optimization techniques to find the optimum frequency plan. Such algorithms will be known to the person skilled in the art and will for brevity and clarity not be described further herein.

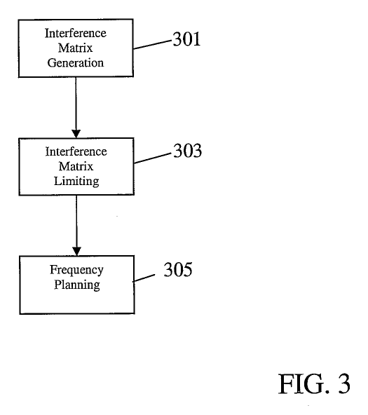

FIG. 3 illustrates a method of frequency planning in accordance with some embodiments of the invention. Specifically, FIG. 3 can illustrate the operation of the frequency planner 115 of FIGS. 1 and 2 and will be described with reference thereto.

The method initiates in step 301 wherein an interference matrix comprising interference relationships between different cells is determined by the interference matrix processor 201.

Frequency planning for a GSM cellular communication system typically comprises evaluating the potential interference that may be caused in one cell by transmission in another cell. Specifically, an interference relationship is determined for two cells under the assumption that they are allocated the same carriers. The interference relationship may for example be determined as a carrier to interference ratio or as a penalty value which results if the two cells are allocated the same frequency (or adjacent frequencies).

For example a simplified co-channel interference matrix may be given by

| | A | B | C | D | E | F |
|---|---|---|---|---|---|---|
| A | | 1 | 1 | 3 | 1 | 2 |
| B | 1 | | 0 | 0 | 4 | |
| C | 2 | 0 | | 0 | | 2 |
| D | 5 | 1 | 0 | | 1 | 4 |
| E | 1 | 3 | 0 | 0 | | 0 |
| F | 3 | 0 | 4 | 5 | 1 | |

where each entry is indicative of a penalty value that reflects the interference level that will arise if the same carrier is allocated to the corresponding cell of the row and column.

In the example each column represents the transmitting cell and each row represents the receiving cell. For example, if cell B and E are allocated the same carrier frequency, the interference relationship is expected to be such that a penalty value of four will be assigned for transmissions from cell E (as received in cell B) and a penalty value of three will be assigned for transmissions from cell B (as received in cell E). These penalty values can then be used by a frequency planning algorithm that seeks to reduce the total resulting penalty value.

Conventionally, the interference matrix is determined by individually determining the interference relationships (such as the expected carrier to interference ratio or a penalty value) from propagation predictions, transmit power assumptions and/or measurements in the field (e.g. by using reports from the mobile station).

Various methods and approaches for generating an interference matrix comprising interference relationships between cells of a cellular communication system will be known to the person skilled in the art and need not be described in further detail.

It will be appreciated that the exemplary interference matrix for clarity is unrealistically small and that a practical interference matrix will be much larger and will typically comprise hundreds of cells with potentially each cell having a large number of interference relationships with other cells. However, frequency planning based on such large matrices becomes exceedingly cumbersome, slow and resource demanding.

In the method of FIG. 3, step 301 is followed by step 303 wherein the number of interference relationships for each cell is limited to a given maximum number N.

Specifically, the interference matrix limiter 203 can determine a number N of interference relationships which will be maintained for each cell. The number N can depend on the frequency re-use pattern for the frequency plan and in particular the number of frequencies which are available for the frequency plan are used to determine how many frequencies should be maintained.

For example, in a typical GSM frequency plan, a re-use of 5×3 can be used. This means that a total of fifteen frequencies are to be planned for the system (typically such a reuse pattern is used for BCCH (Broadcast/pilot) frequencies whereas TCH (traffic) frequencies have a higher reuse pattern such as a 4×3 reuse pattern using twelve frequencies).

When frequency planning a 5×3 reuse pattern, it is expected that the nearest cell reusing that frequency will on average be the fifteenth closest/highest penalty. Typically, this may vary between say the tenth and twenty-fifth highest interferer due to umbrella sites, concentrated clusters and other specific conditions. Accordingly, to provide an efficient trade-off between the frequency plan optimisation performance and the complexity reduction, the number N of interference relationships to consider may be selected such that there is a high probability that the cell which will be allocated the same frequency is included in the interference matrix. Specifically, it has been found that by including between one and three times the number of frequencies of the reuse pattern results in a substantial complexity reduction for many scenarios while providing an accurate and high performance frequency planning.

It is often used to include a number of additional frequencies which are not part of the reuse pattern in the frequency planning. Such wildcard or joker frequencies can be allocated to cells in particular critical areas and provide for increased flexibility and optimisation possibility for the frequency plan. When determining the number N of interference relationships to maintain, available frequencies which not allocated to the reuse pattern can be included for improved performance. For example, using a safety factor of two for a 5×3 reuse pattern with three wildcard frequencies, the number of interference relationships to consider for each cell can be limited to N=36.

For many practical cellular communication systems, this will provide a very substantial complexity reduction while not significantly affecting the accuracy or performance of the frequency planning.

As a specific example, the interference matrix limiter 203 can perform the following operations:
Multiply the reuse pattern size, including wildcard frequencies, by a safety factor to produce the ‘significant interferer count’ N.
For each cell, sort the interferers in descending order of penalty.
Provisionally remove all penalties not in the top N ‘significant interferer count’ relationships per cell.

The removal of penalties which are not part of the top N most significant interferers for the cell can simply be achieved by amending the data value in the appropriate position in the interference matrix such that it indicates that no interference is caused between the cells. For example, for a penalty value interference matrix the appropriate penalty values can simply be set to zero.

The limiting of the number of interference relationships considered can be subject to the preservation of the two-way relationships between interference. Thus, if the interference relationship from cell A to cell B is in the top ‘significant interferer count’ whereas the interference relationship from cell B to cell A is not, then the interference relationship representing interference from cell B to cell A is still maintained. This may allow improved performance and optimization by the frequency planning operation.

It will be appreciated that the preservation of the two-way relationships can be achieved by maintaining more than N interference relationships for a given cell or by removing one or more interference relationships that are amongst the top N interference relationships.

Step 303 is followed by step 305 wherein a frequency planning operation is performed by the frequency plan processor 205 based on the interference relationship. It will be appreciated that any frequency plan optimisation algorithm based on an interference matrix may be used without detracting from the invention.

It will be appreciated that although the above description has focused on embodiments wherein an interference matrix is first generated and then limited, these steps may be integrated and performed together.

For example, when a new interference relationship value, say a penalty value, is determined for the interference relationship, it may be determined if more than N interference relationship values are already determined for the cell. If not, the value is entered in the matrix. Otherwise, the new value may be compared to the lowest interference value, say the lowest penalty value, and if it is higher it is entered in the matrix and the lowest value is removed. Otherwise the new value is discarded. It will also be appreciated that although the above description has focused on embodiments wherein an interference matrix is limited before the frequency planning operation, these steps may be integrated and performed together.

In some embodiments, the interference matrix comprises interference relationships for the individual carrier frequencies of the cell, i.e. each cell row/column is further divided into sub-rows and sub-columns corresponding to the individual carriers. The same process as previously described can be applied with a first number of individual carrier frequency interference relationships being selected for each cell and with the resulting penalty value used by the frequency planning being determined for the whole cell.

In some cases the set of individual carrier frequencies available for the frequency planning can be divided into different sets of non-overlapping carrier frequencies. For example some carrier frequencies or cells can be planned as a different cell layer than others or can belong to multi-band cells. In such cases it is possible to plan for a different level of re-use in the different cell layer if the carrier frequencies are divided into a first set corresponding to one layer and a second non-overlapping set corresponding to another layer. For example, a set of nine carrier frequencies can be fully allocated to inner concentric cells and a 3×3 reuse pattern can be used for this set of carrier frequencies. At the same time, another set of fifteen carrier frequencies can be used for the macro-cells at a 5×3 reuse pattern. In this case, the first number of carrier frequency interference relationships considered by the frequency planning can be determined as 2*(9+15)=48 interference relationships. Specifically, the interference relationships can be selected as 2*9=18 carrier frequency interference relationships for the first set of cells and 2*15=30 carrier frequency interference relationships for the second set of cells (in these examples a constant of two has been used to determine the interference relationships from the number of available carrier frequencies but it will be appreciated that any relationship can be used).

The described systems can provide many advantages including a complexity reduction and in particular can provide for a reduction of the processing time to produce a frequency plan and of the memory requirements for the automatic frequency planning software.

Furthermore, the described method can be simple to implement in software and will significantly improve frequency planning performance particularly in more difficult, dense networks, at minimal cost in terms of degradation of the frequency plan quality. The saving in memory requirements will allow automatic frequency planning to be executed on a lower specification computing platform, such as PCs, thereby reducing cost.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A method of frequency planning for a cellular communication system, the method comprising:
generating an interference matrix comprising interference relationships between different cells;
for each cell of the interference matrix limiting a number of interference relationships to a first number of highest interference relationships; and
performing a frequency planning using the interference matrix.

2. The method of claim 1 further comprising determining the first number in response to a frequency re-use pattern for the cellular communication system.

3. The method of claim 1 further comprising determining the first number in response to a number of frequencies available for the frequency planning.

4. The method of claim 3 wherein the number of frequencies includes a number of available frequencies not allocated to the reuse pattern.

5. The method of claims 3 wherein the first number is determined as the number of available frequencies multiplied by a constant.

6. The method of claim 1 wherein the limiting is by setting matrix values for cell combinations not corresponding to the first number of highest interference relationships to a value indicative of no interference existing between cells associated with the matrix values.

7. The method of claim 1 wherein the limiting is such that if an interference relationship between a first and a second cell is one of the first number of highest interference relationships for interference from the first to the second cell, the interference relationship for interference from the second cell to the first cell is maintained in the interference matrix.

8. The method of claim 1 wherein the interference relationship comprises a plurality of interference relationships for a set of carrier frequencies.

9. The method of claim 8 wherein the set of carrier frequencies are divided into a first and second set of non-overlapping carrier frequencies and the first number comprises a second number corresponding to interference relationships of carrier frequencies in the first set and a second number corresponding to interference relationships of carrier frequencies in the second set.

10. An apparatus for frequency planning of a cellular communication system, the apparatus comprising:
means for generating an interference matrix comprising interference relationships between different cells;
means for, for each cell of the interference matrix, limiting a number of interference relationships to a first number of highest interference relationships; and
means for performing a frequency planning using the interference matrix.
